(19) United States
(12) Patent Application Publication
(10) Pub. No.: US 2023/0273867 A1
(43) Pub. Date: Aug. 31, 2023

(54) STORAGE APPARATUS WITHOUT SINGLE FAILURE POINT

(71) Applicant: SUZHOU KUHAN INFORMATION TECHNOLOGIES CO., LTD., Suzhou, Jiangsu (CN)

(72) Inventors: Di XU, Suzhou, Jiangsu (CN); Kwok Wah YEUNG, Suzhou, Jiangsu (CN)

(21) Appl. No.: 18/007,466

(22) PCT Filed: Jul. 23, 2021
(86) PCT No.: PCT/CN2021/108293

§ 371 Date: Jan. 30, 2023

(30) Foreign Application Priority Data
Jul. 30, 2020 (CN) 202010753901.3

(51) Int. Cl. G06F 11/20; G06F 11/07; G06F 13/42

(52) U.S. Cl. CPC G06F 11/2023; G06F 11/0793; G06F 13/4234

(57) ABSTRACT

Disclosed is a storage apparatus without a single failure point. The apparatus comprises two storage controllers and a plurality of storage devices. A plurality of storage devices are connected between the two storage controllers by means of a plurality of point-to-point data buses, so as to form a loop; one storage controller forms a transmission and control bus group with some of the storage devices, and the other storage controller forms another transmission and control bus group with the remaining storage devices; when one of the two storage controllers fails, the plurality of storage devices and the other storage controller form a transmission and control bus group so as to continue control and data transmission; When any one of the plurality of storage devices fails, the remaining storage devices are rearranged and form two new transmission and control bus groups with the two storage controllers so as to continue control and data transmission.

### FIELD

The invention generally relates to memory field, in particular to a storage apparatus without a single failure point.

### BACKGROUND

In today's enterprise-class high-performance and high-availability storage system, the reliability, accessibility and serviceability of data are crucial. Therefore, it is necessary for the system to have no single failure point. In the traditional storage system, as shown in FIG. 1a, server 11 communicates with a plurality of storage disks 31 and 41 through switch 21, but there are many single failure points in this system. If server 11 fails or switch 21 fails or storage controller or any storage device in storage disks 31 and 41 fails, data will be inaccessible, unrecoverable and lost. The system in FIG. 1b can eliminate single failure points in servers and switches by adding servers 12 and switches 22, but storage controllers and storage devices will still generate single failure points. As shown in FIG. 1c, the solution of today's system is to replicate all storage disks to form replicated storage disks 31′, 41′. However, in the mass data storage center, such a solution at a high cost.

### SUMMARY OF THE INVENTION

The purpose of the invention is to provide a storage apparatus without a single failure point.

This application discloses a storage apparatus comprising two storage controllers and a plurality of storage devices, wherein the plurality of storage devices are connected between the two storage controllers via a plurality of point-to-point data buses to form a loop, one of the two storage controller and a portion of the storage devices form a transmission and control bus group, and the other storage controller and the remaining storage devices form another transmission and control bus group;

Wherein, when one of the two storage controllers fails, the plurality of storage devices and the other storage controller form a transmission and control bus group so as to continue control and data transmission; When any one of the plurality of storage devices fails, the remaining storage devices are rearranged and form two new transmission and control bus groups with the two storage controllers so as to continue control and data transmission.

The application also discloses a storage apparatus comprising two storage controllers and a plurality of storage devices, wherein the plurality of storage devices are connected between the two storage controllers by a plurality of point-to-point data buses to form a linear link;

Wherein when one of the two storage controller fails, the plurality of storage devices and the other storage controller form a transmission and control bus group; when any one of the plurality of storage devices fails, the other storage devices on both sides of the failed storage device respectively form two transmission and control bus groups with the storage controllers on both sides.

In a preferred embodiment, the storage controller has dual ports.

In a preferred embodiment, the plurality of point-to-point data bus are bi-directional point-to-point data buses.

In a preferred embodiment, the control and data transmission between the storage controller and the connected storage device is performed via a shared bi-directional data bus, and the control and data transmission between the adjacent storage devices in the plurality of storage devices is performed via a shared bi-directional data bus.

In a preferred embodiment, the plurality of point-to-point data buses are one-way point-to-point data buses.

In a preferred embodiment, the control and data transmission between the storage controller and the connected storage device is performed via a shared one-way data bus, and the control and data transmission between the adjacent storage devices in the plurality of storage devices is performed via a shared one-way data bus.

In a preferred embodiment, the storage controller and the connected storage device are connected through a one-way point-to-point control bus, and the adjacent storage devices in the plurality of storage devices are connected through a one-way point-to-point control bus.

In a preferred embodiment, the storage controller and the connected storage device are connected through a bi-directional point-to-point control bus, and the adjacent storage devices in the plurality of storage devices are connected through a bi-directional point-to-point control bus.

The application also discloses a storage device, the storage device comprises two sets of ports. The storage device supports a concurrent bus mode, and the concurrent bus mode enable the two sets of ports of the storage device independently be connected to two different bus ports; When the concurrent bus mode is enabled, the two port groups are set to an output state simultaneously, or set to an input state simultaneously, or one port group is set to the output state and the other port group is set to the input state, or one port group is set to the input state and the other port group is in an undriven Hi-Impedance state, or one port group is set to the output state and the other port group is in the undriven Hi-Impedance state; When the concurrent bus mode is not enabled, the two port groups are in a low-latency bypass mode.

In a preferred embodiment, each of the two groups of ports includes one or more ports.

In a preferred embodiment, one or more of the ports included in the port group is used for data transmission, while one or more are used for control.

In a preferred embodiment, the two groups of ports are respectively read or write.

In a preferred embodiment, the concurrent bus mode is implemented by port logic, and the port logic and a memory block are encapsulated in a same die (silicon die) to form the storage device.

In a preferred embodiment, the concurrent bus mode is implemented by port logic which is encapsulated in a separate die, and the separate die is packaged in the same package with one or more separately encapsulated memory block dies to form the storage device.

The description of the present application describes a large number of technical features which are distributed in various technical solutions. If all possible combinations of technical features (i.e. technical solutions) of the present application were to be listed, the description would be too lengthy. To avoid this problem, technical features disclosed in the above summary of the invention of the present application, technical features disclosed in the following embodiments and examples and technical features disclosed in the drawings may be combined with each other to constitute new technical solutions (these technical solutions are deemed to have been described in the description), unless the combination of technical features is not technically feasible. For example, the feature A+B+C is disclosed in one embodiment, and the feature A+B+D+E is disclosed in another embodiment. The feature C and D are equivalent technical means that play the same role. Technically, only one can be used, and it is impossible to use both. The feature E can be combined with the feature C technically. Therefore, the scheme of A+B+C+D should not be considered to have been recorded because it is not technically feasible, and the scheme of A+B+C+E should be considered to have been recorded.

### BRIEF DESCRIPTION OF THE DRAWINGS

The non-limiting and non-exhaustive embodiments of the present application are described with reference to the following drawings, wherein, unless otherwise stated, the same reference numerals refer to the same part in each drawing.

FIG. 1a shows the schematic diagram of the storage system in the prior art.

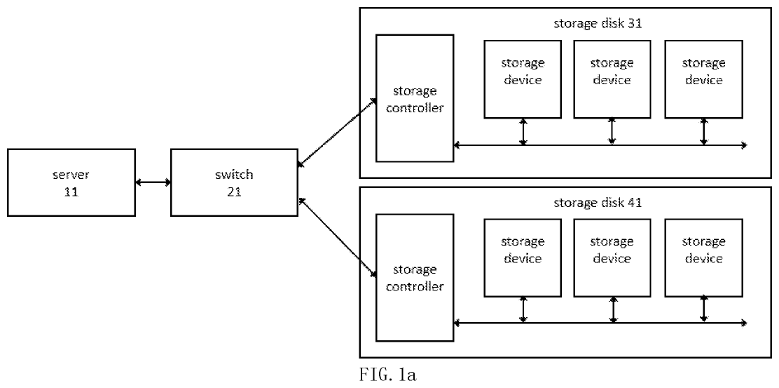

FIG. 1b is a schematic diagram in the prior art where the storage controller and storage device are single failure points.

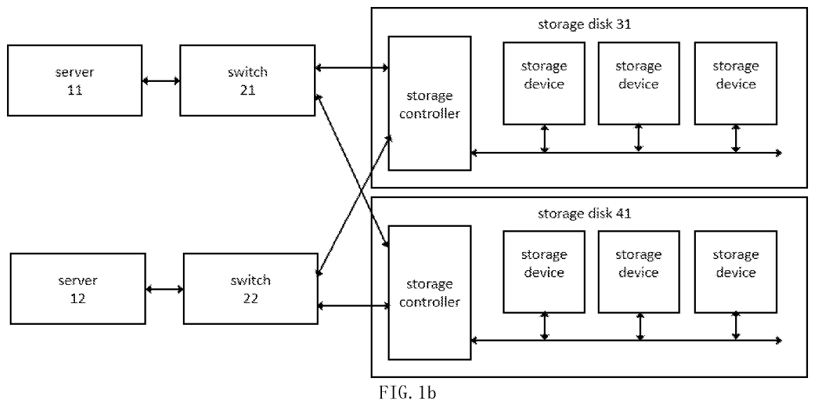

FIG. 1c shows the schematic diagram of the prior art that needs to replicate storage disks to solve the single failure point problem.

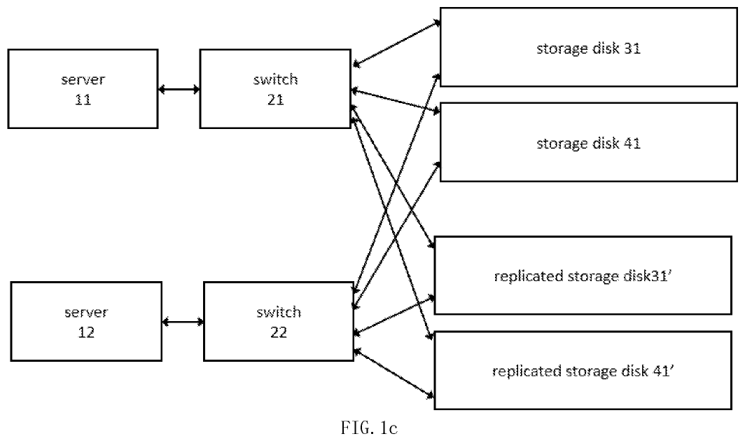

FIG. 2a shows the schematic diagram of the storage apparatus in an embodiment of the invention.

FIG. 2b shows the schematic diagram of the storage apparatus in another embodiment of the invention.

FIG. 2c shows the schematic diagram of the storage apparatus in another embodiment of the invention.

FIG. 3a shows the schematic diagram of two transmission and control bus groups allocated between dual controllers and devices in an embodiment of the invention.

FIG. 3b shows the schematic diagram of two transmission and control bus groups allocated between dual controllers and devices in another embodiment of the invention.

FIG. 3c shows the schematic diagram of regrouping transmission and control bus groups after a controller failure in an embodiment of the invention.

FIG. 3d shows the schematic diagram of regrouping transmission and control bus groups after a storage device failure in an embodiment of the invention.

FIG. 3e shows the schematic diagram of regrouping transmission and control bus groups after a storage device failure in another embodiment of the invention.

FIG. 3f shows the schematic diagram of regrouping transmission and control bus groups after a storage device failure in another embodiment of the invention.

FIG. 4a shows the schematic diagram of the storage apparatus in an embodiment of the invention.

FIG. 4b shows the schematic diagram of the storage apparatus in another embodiment of the invention.

FIG. 4c shows the schematic diagram of the storage apparatus in another embodiment of the invention.

FIG. 5a shows the schematic diagram of the storage apparatus in an embodiment of the invention.

FIG. 5b shows the schematic diagram of the storage apparatus in another embodiment of the invention.

FIG. 5c shows the schematic diagram of the storage apparatus in another embodiment of the invention.

FIG. 6a shows the schematic diagram of regrouping transmission and control bus groups after a controller failure in an embodiment of the invention.

FIG. 6b shows the schematic diagram of regrouping transmission and control bus groups after a storage device failure in an embodiment of the invention.

FIG. 7a shows a storage device schematic diagram with dual ports in an embodiment of the invention, wherein each port support concurrent bus mode.

FIG. 7b shows a storage device schematic diagram with dual-port groups in an embodiment of the invention, wherein each dual-port group support concurrent bus mode.

FIG. 8a shows the schematic diagram of two transmission and control bus groups allocated between dual controllers and devices in an embodiment of the invention.

FIG. 8b shows the schematic diagram of reorganizing the daisy chain using a dual-port storage device after a controller failure in an embodiment of the invention.

FIG. 8c shows the schematic diagram of reorganizing the daisy chain using a dual-port storage device after a controller failure in an embodiment of the invention.

### DETAILED DESCRIPTION

Various aspects and embodiments of this application will be described. The following description provides specific details of the description used to thoroughly understand and implement these embodiments. However, those skilled in the art will understand that this application can be practiced without many of these details.

In addition, some well-known structures or functions may not be shown or described in detail in order to be concise and avoid unnecessary blurring of relevant descriptions.

The terms used in the description given below are intended to be interpreted in their most extensive and reasonable manner, even if they are used in conjunction with the detailed description of certain specific embodiments of this application. Some terms may even be emphasized below. However, any term intended to be interpreted in any restricted way will be clearly and specifically defined in this detailed description.

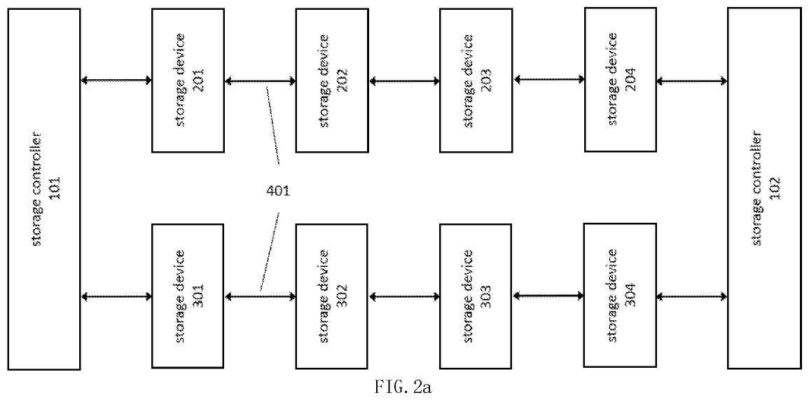

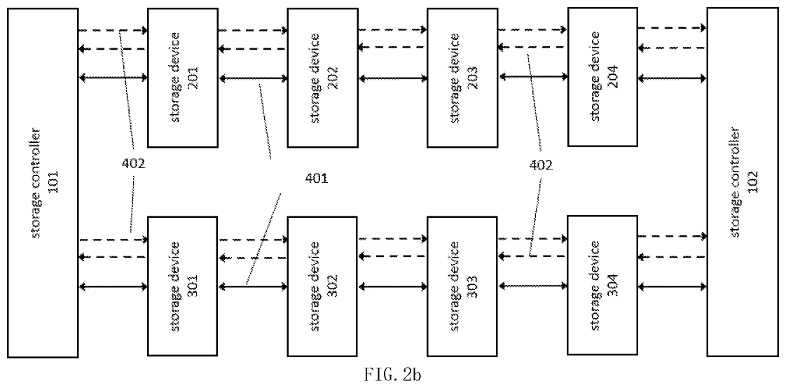

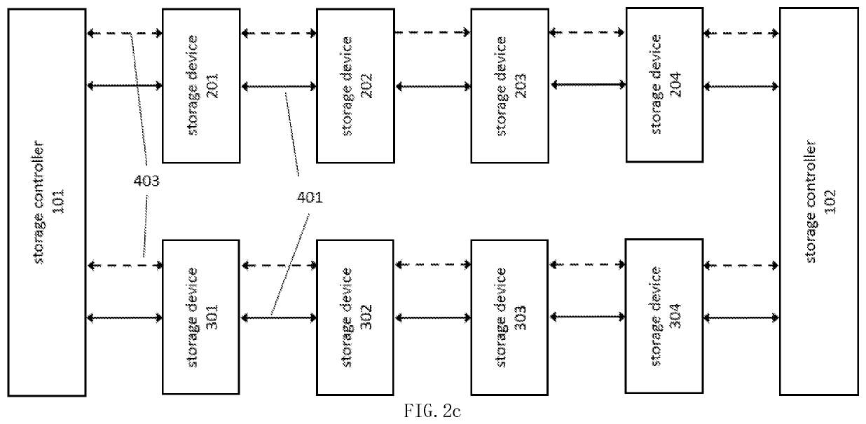

An embodiment of this application discloses a storage apparatus. FIG. 2a shows the schematic diagram of the storage apparatus, the storage apparatus including two storage controllers (101,102) and a plurality of storage devices (201-204, 301-304). The plurality of storage devices (201-204, 301-304) are coupled to form a loop between the two storage controllers (101,102) through a plurality of point-to-point data bus (401). In an embodiment, the storage controllers (101,102) have dual ports.

In an embodiment, as shown in FIG. 2a, the plurality of point-to-point data buses (401) are bi-directional point-to-point data buses. In an embodiment, the control and data transmission between the storage controllers (101, 102) and the connected storage devices (201, 204, 301, 304) is performed via a shared bi-directional data bus, and the control and data transmission between the adjacent storage devices in the plurality of storage devices (201-204, 301-304) is performed via a shared bi-directional data bus, i.e. the data transmission and control share the same bus.

It should be understood that in other embodiments of this application, the plurality of point-to-point data buses (401) can also be one-way point-to-point data buses. In this embodiment, the control and data transmission between the storage controller and the connected storage device is performed via a shared one-way data bus, and the control and data transmission between the adjacent storage devices in the plurality of storage devices is performed via a shared one-way data bus, i.e. the data transmission and control share the same bus.

In an embodiment, as shown in FIG. 2b, the storage controllers (101,102) and the connected storage devices (201, 204, 301, 304) are connected through a one-way point-to-point control bus (402), and the adjacent storage devices in the plurality of storage devices (201-204, 301-304) are connected through a one-way point-to-point control bus (402).

In an embodiment, as shown in FIG. 2c, the storage controllers (101,102) and the connected storage devices (201, 204, 301, 304) are connected through the bi-directional point-to-point control bus (403), and the adjacent storage devices in the plurality of storage devices (201-204, 301-304) are connected through the bi-directional point-to-point control bus (403).

Wherein, one storage controller and some storage devices form a transmission and control bus group, and the other storage controller and the remaining storage devices form another transmission and control bus group.

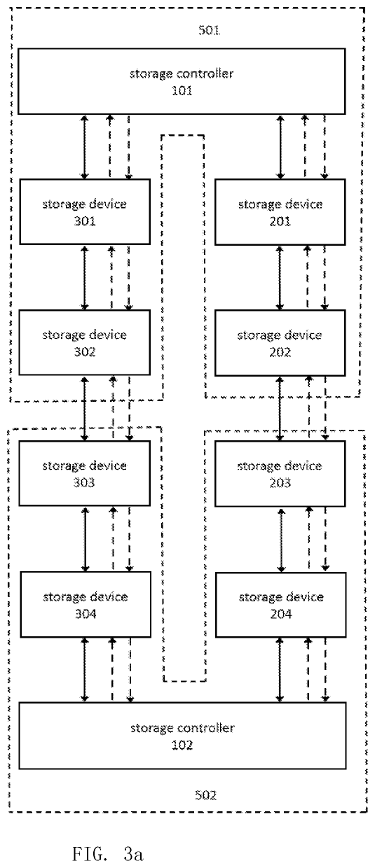

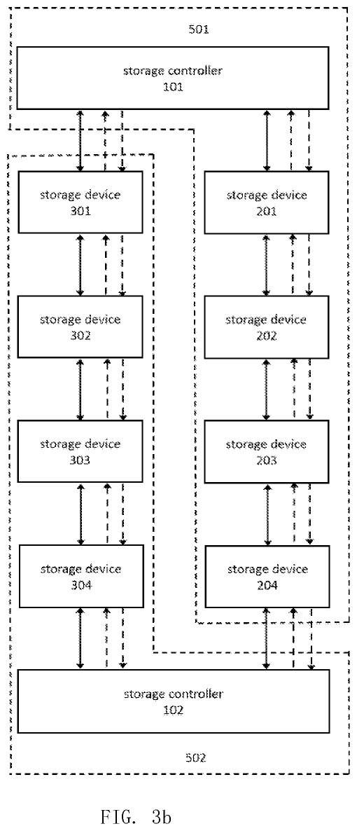

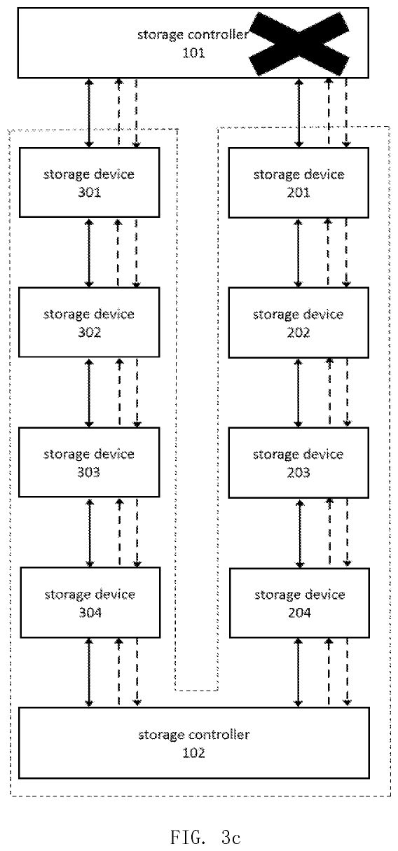

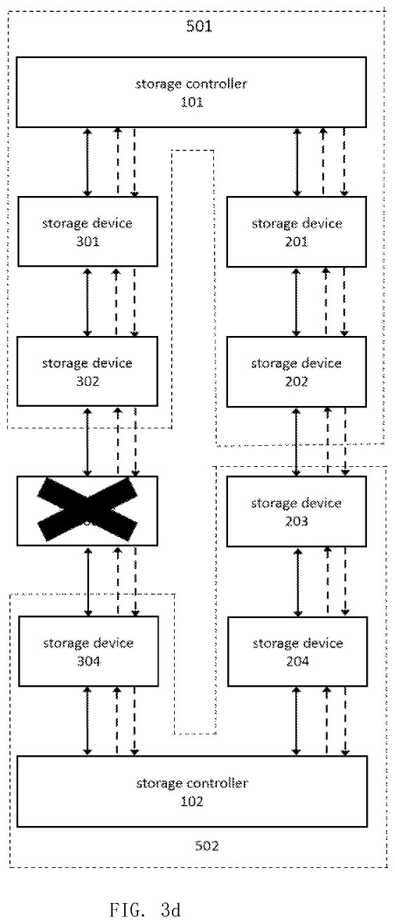

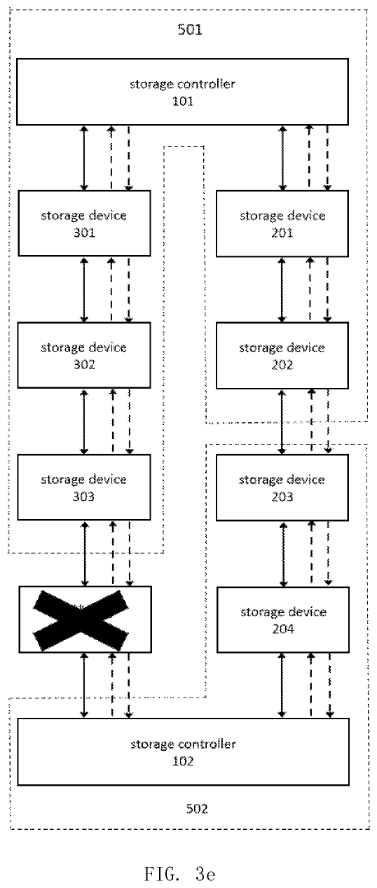

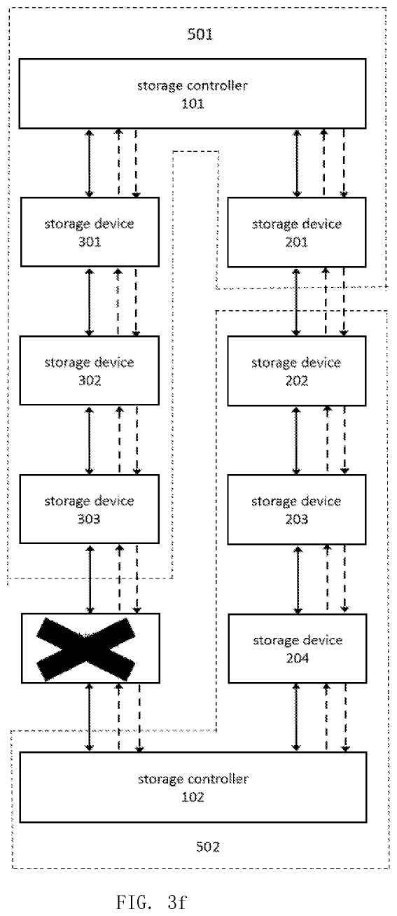

As shown in FIG. 3a, the storage controller (101) and the storage devices (201, 202, 301, 302) form the first transmission and control bus group (501), and the storage controller (102) and the storage devices (203, 204, 303, 304) form the second transmission and control bus group (502).

As shown in FIG. 3b, the storage controller (101) and the storage devices (201, 202, 203, 204) form the first transmission and control bus group (501), and the storage controller (102) and the storage devices (301, 302, 303, 304) form the second transmission and control bus group (502).

It should be understood that the connection shown in FIG. 3a is preferable to the connection shown in FIG. 3b in that each storage controller is physically closer to the connected storage device.

In an embodiment, when one of the two storage controllers fails, the plurality of storage devices and the other storage controller form a transmission and control bus group so as to continue control and data transmission; When any one of the plurality of storage devices fails, the remaining storage devices are rearranged and form two new transmission and control bus groups with the two storage controllers so as to continue control and data transmission.

As shown in FIG. 3c, when the storage controller (101) fails, the storage controller (102) is connected with the storage devices (201-204, 301-304) to form a transmission and control bus group, which can continue to perform control and data transmission.

In the apparatus of this embodiment, if one of the two storage controllers fails, the remaining storage controllers will get this information. There are many methods for failure detection of the storage controller. In an embodiment, the host or server in the external control system can detect the status of the failure storage controller through the abnormal state response and notify the remaining storage controllers. In another embodiment, two storage controllers in the apparatus intermittently probe each other's status through the bus to observe the other's normality. In another embodiment, the two storage controllers in the apparatus intermittently report the status to each other through the bus and find that the other has entered the failure state through the timeout timer. When a storage controller fails, the remaining storage controllers take over all the storage devices on the bus by setting the ports of the storage devices through the control and data bus, thus achieving a non-single failure point for the storage controller.

As shown in FIG. 3d, the storage controllers and the storage devices are connected in the manner shown in FIG. 3a. When the storage device (303) fails, the control and data transmission between other storage devices and the storage controllers will not be affected. The storage controller (102) can recover the lost data of the storage device (303) from the RAID data of the remaining storage device (203, 204, 304).

As shown in FIG. 3e, the storage controllers and the storage devices are connected in the manner shown in FIG. 3a. When the storage device (304) fails, the control and data transmission between other storage devices and the storage controllers will not be affected. However, in other embodiments of the present application, the storage controller and the storage device can also be rearranged. For example, referring to FIG. 3f, the storage controller (101) and the storage devices (201, 301-303) form a transmission and control bus group, and the storage controller (102) and the storage devices (202-204) form another transmission and control bus group. In this embodiment, two new transmission and control bus groups can be formed, being able to continue control and data transmission.

In the apparatus of this embodiment, if one of the plurality of storage devices fails, the storage controller in the transmission and control bus group where the failure storage device is located will be able to detect it. There are many methods of failure detection. The controller can conduct integrated detection based on the non-response of the storage device, the failure status report of the storage device, the read date error of the storage device, etc. After the failure storage device is detected, the two storage controllers in the apparatus can regroup the transmission and control bus group to continue to control the remaining storage devices and balance the performance. The apparatus can recover the data lost by the failed storage device through the data recovery algorithm, such as RAIDS, RAID6, etc., so that there is no single failure point of the storage device, while avoiding the need for data replication, and greatly reducing the cost of storage facilities.

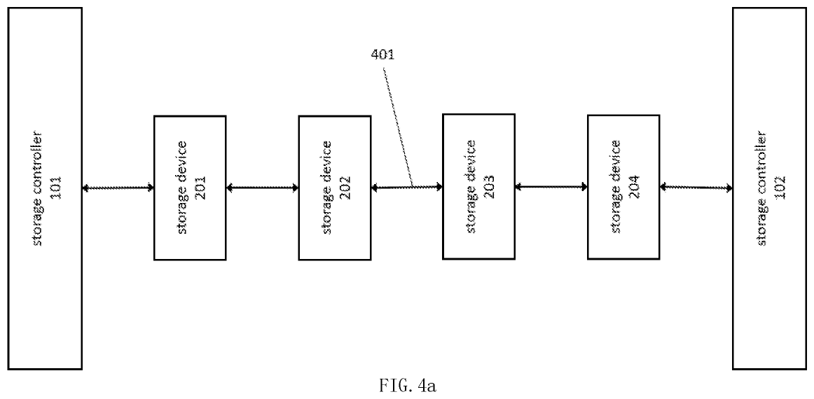

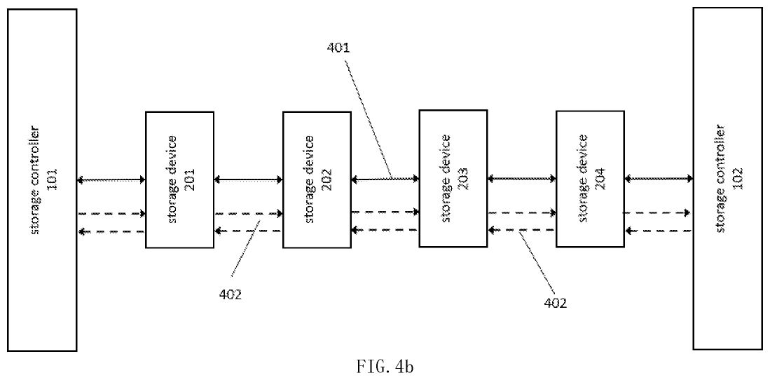

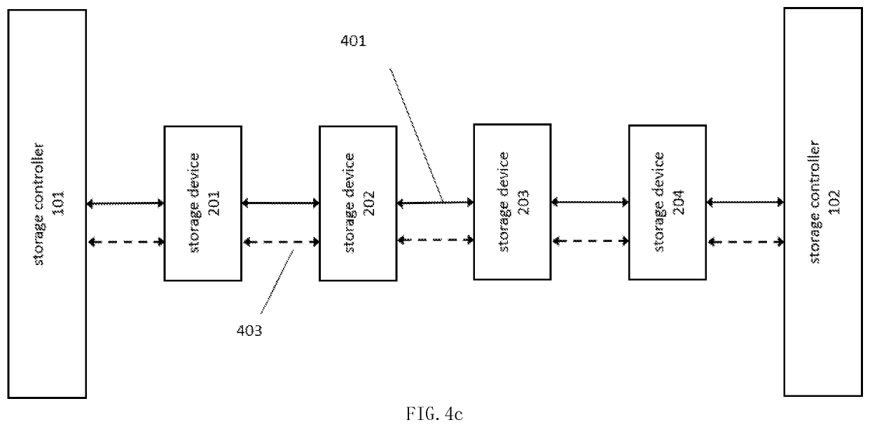

An embodiment of the application discloses a storage apparatus. FIG. 4a shows the schematic diagram of the storage apparatus, including two storage controllers (101,102) and a plurality of storage devices (201-204). The plurality of storage devices (201-204) are connected to form a linear link between the two storage controllers (101,102) through a plurality of point-to-point data buses (401).

In an embodiment, as shown in FIG. 4a, the plurality of point-to-point data buses (401) are bi-directional point-to-point data buses. In an embodiment, shared bi-directional data buses are used for control and data transmission between the storage controllers (101,102) and the connected storage devices (201, 204), and between the adjacent storage devices in the plurality of storage devices (201-204), i.e. the data transmission and control share the same bus.

In an embodiment, as shown in FIG. 4b, the storage controllers (101,102) and the connected storage devices (201, 204) are connected through a one-way point-to-point control bus 402, and the adjacent storage devices in the plurality of storage devices (201-204) are connected through a one-way point-to-point control bus 402.

In an embodiment, as shown in FIG. 4c, the storage controllers (101,102) and the connected storage devices (201, 204) are connected through a bi-directional point-to-point control bus 403, and the adjacent storage devices in the plurality of storage devices (201-204) are connected through a bi-directional point-to-point control bus 403.

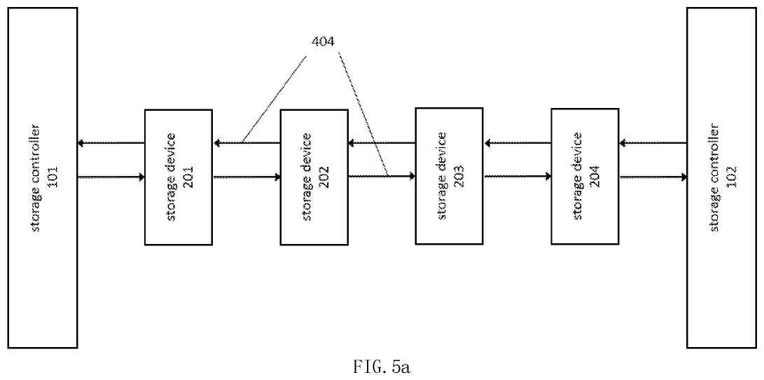

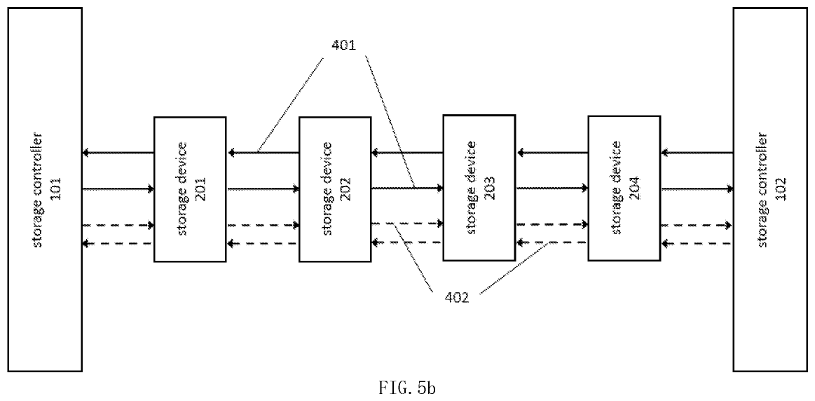

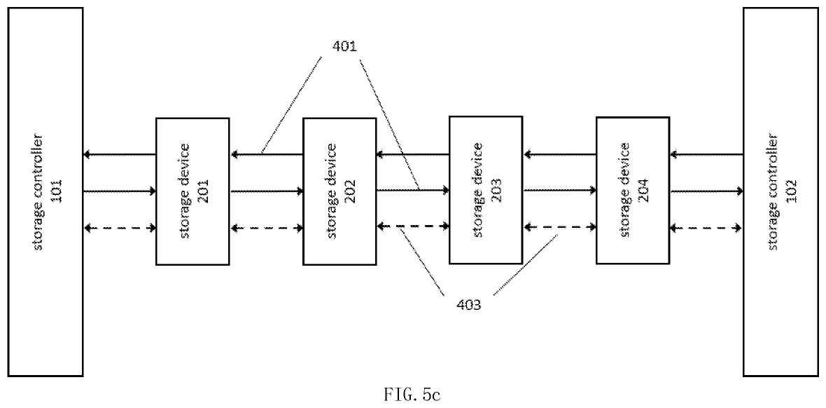

In an embodiment, as shown in FIG. 5a, the plurality of point-to-point data buses (401) can also be one-way point-to-point data buses 404. In this embodiment, the control and data transmission between the storage controller and the connected storage device is performed via a shared one-way data bus, and the control and data transmission between the adjacent storage devices in the plurality of storage devices is performed via a shared one-way data bus, i.e. the data transmission and control share the same bus.

In an embodiment, as shown in FIG. 5b, the plurality of storage devices (201-204) are connected through a plurality of point-to-point data buses (401), and the storage controllers (101,102) and the connected storage devices (201, 204) are connected through a one-way point-to-point control bus (402), and the adjacent storage devices in the plurality of storage devices (201-204) are connected through a one-way point-to-point control bus (402).

In an embodiment, as shown in FIG. 5c, the plurality of storage devices (201-204) are connected through a plurality of point-to-point data buses (401), and the storage controllers (101,102) and the connected storage devices (201, 204) are connected through a bi-directional point-to-point control bus (403), and the adjacent storage devices in the plurality of storage devices (201-204) are connected through a bi-directional point-to-point control bus (403).

Wherein when one of the two storage controller fails, the plurality of storage devices and the other storage controller form a transmission and control bus group; When any one of the plurality of storage devices fails, the other storage devices on both sides of the failed storage device respectively form two transmission and control bus groups with the storage controllers on both sides.

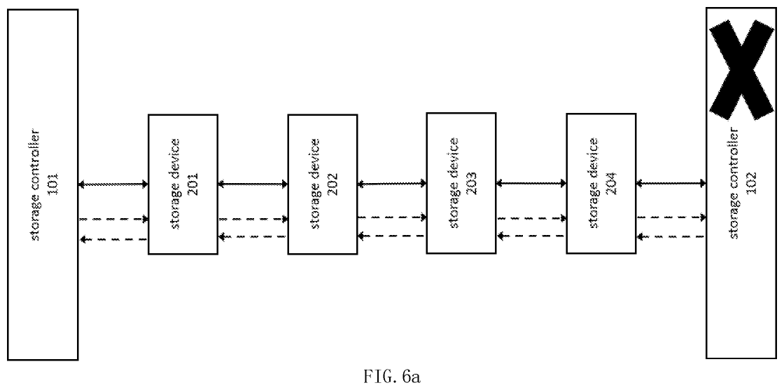

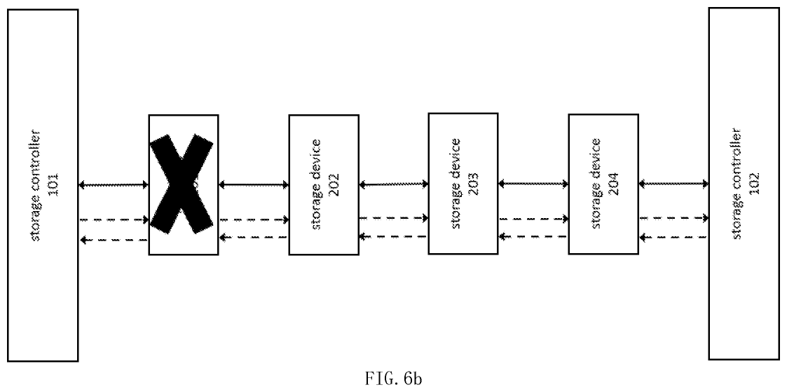

As shown in FIG. 6a, the storage controllers and the storage devices are connected in the manner shown in FIG. 4b. When the storage controller (102) fails, the storage device (201-204) and the storage controller (101) form a transmission and control bus group.

As shown in FIG. 6b, the storage controllers and the storage devices are connected in the manner shown in FIG. 4b. When the storage device (201) fails, the storage device (202-204) and the storage controller (102) form a transmission and control bus group.

Another embodiment of this application discloses a storage device. The storage device has two bi-directional port groups. The storage device supports a concurrent bus mode. The storage device supporting a concurrent bus mode that enables the two port groups of the storage device to be independently connected to two different bus interfaces. When the concurrent bus mode is enabled, the two port groups are set to an output state simultaneously, or set to an input state simultaneously, or one port group is set to the output state and the other port group is set to the input state, or one port group is set to the input state and the other port group is in an undriven Hi-Impedance state, or one port group is set to the output state and the other port group is in the undriven Hi-Impedance state. When the concurrent bus mode is not enabled, the two port groups are in a low-latency bypass mode. The storage device in this embodiment is used to implement the storage apparatus described above.

In an embodiment, each of the two groups of bi-directional port groups may include one or more ports. In an embodiment, one or more ports in the bi-directional port group are used for data transmission, and one or more ports in the bi-directional port group are used for control.

In an embodiment, the two bi-directional port groups perform read or write operations respectively.

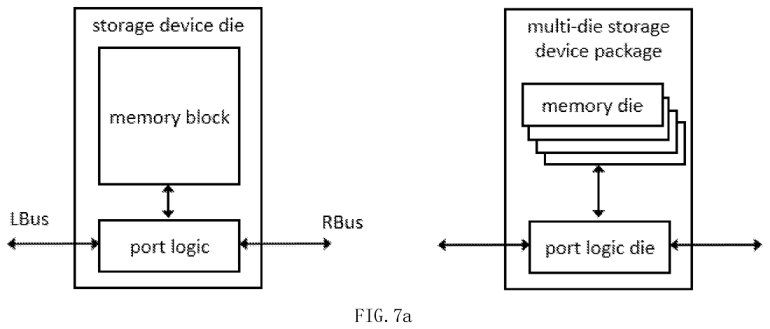

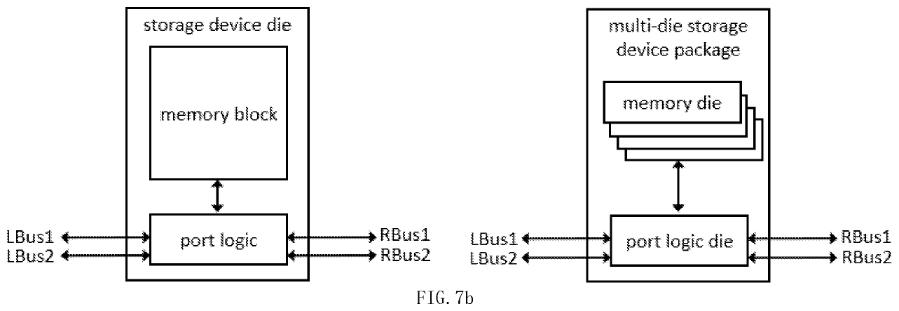

As shown in the schematic diagram on the left of FIG. 7a, the storage device includes memory block and port logic. The memory block and port logic are encapsulated in the same die. The concurrent bus mode is realized through the port logic. The port logic includes two groups of ports, each of which includes one or more ports. For example, in the schematic diagram on the left side of FIG. 7a, the two groups of ports in the port logic each include one port, respectively connecting to the bi-directional buses LBus and RBUS. In the schematic diagram on the left side of FIG. 7b, the two groups of ports in the port logic each include two ports, one of which is connected to the bi-directional buses Lbus1 and Lbus2, and the other is connected to the bi-directional buses RBUS1 and RBUS2.

As shown in the schematic diagram on the right side of FIG. 7a, the storage device includes multiple memory blocks and port logic. The multiple memory blocks are encapsulated in a single die, and the port logic is separately encapsulated in a single die. Then they are encapsulated in the same package simultaneously. The concurrent bus mode is realized through the port logic. The port logic includes two groups of ports, and each of the two groups of ports includes one or more ports. For example, in the schematic diagram on the right side of FIG. 7a, the two groups of ports in the port logic each include a port, respectively connecting to the bi-directional buses LBus and RBUS. In the schematic diagram on the right side of FIG. 7b, the two groups of ports in the port logic each include two ports, one of which is connected to the bi-directional buses Lbus1 and Lbus2, and the other is connected to the bi-directional buses RBUS1 and RBUS2.

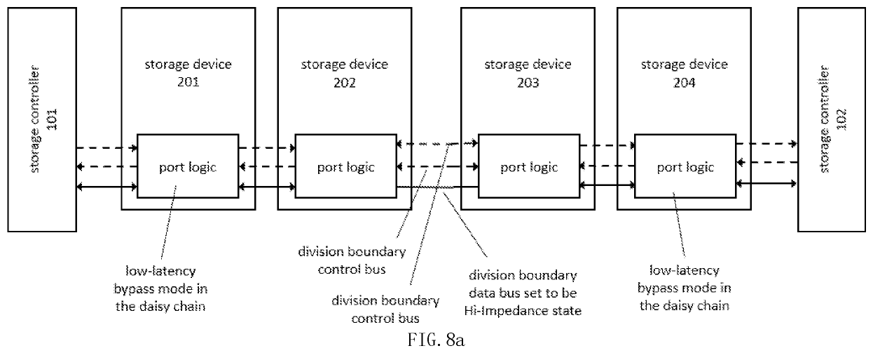

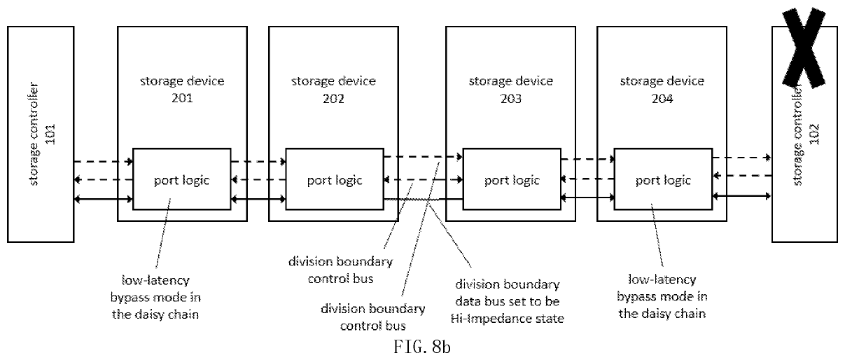

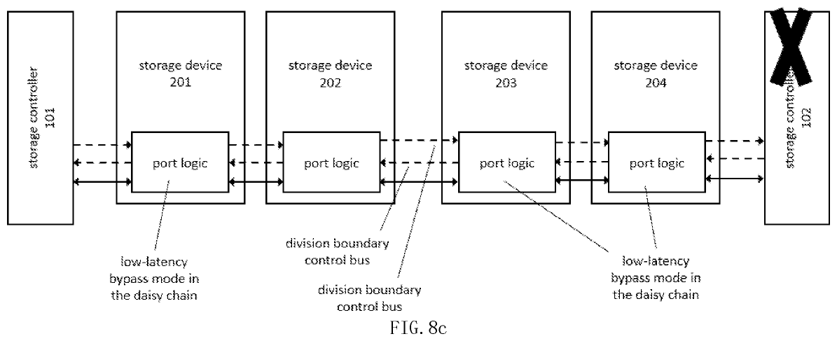

In an embodiment, the storage device in the system of FIG. 4b has two port groups, each port groups supports the storage device in the concurrent bus mode. As shown in FIG. 8a. In this embodiment, each port group has two ports, one for control and one for data. During normal operation, the storage controller (101) forms a transmission and control bus group (daisy chain) with the storage devices (203, 204), the storage controller (102) forms a transmission and control bus group (daisy chain) with the storage devices (201, 202), and the daisy chain division boundary of the storage controller (101) and the storage controller (102) is between the storage device (202) and the storage device (203). Both ends of the division boundary control bus of the node ports of the two daisy chains are set as inputs, and the division boundary data bus is in the undriven Hi-Impedance state. The concurrent mode of the port logic of the storage devices (201, 204) in the two daisy chains is turned off and set to the low-latency bypass mode. When the storage controller (102) fails, as shown in FIG. 8b, the storage controller (101) sets the node port of the storage device (202) from the input state to the output state to control the storage device (203), and then sets the concurrent bus mode of the port logic of the storage device (203) to be closed, as shown in FIG. 8c, the two daisy chains are connected. There are various schemes for rebuilding the daisy chain, and this embodiment is one example.

It is noted that throughout the specification, terms of relationship such as first, second, etc. are used only to distinguish one entity or operation from another entity or operation, and do not necessarily require or imply any actual relationship or sequence between such entities or operations. Moreover, the terms “comprise”, “include” or any other variation thereof are intended to cover non-exclusive inclusion, so that a process, a method, an article or an equipment including a set of elements may include not only those elements, but also other elements not explicitly listed, or elements inherent in such process, method, article or equipment. Without further restriction, the element defined by the statement “comprising a” does not exclude the existence of another same element in the process, method, article or equipment including the element. In the specification, if it is mentioned to perform an operation according to an element, it means to perform the operation at least according to the element, which includes two situations: performing the operation only according to the element, and performing the operation according to the element and other elements. The expressions of multiple, a plurality of means 2 or more than 2.

All documents mentioned in the specification are considered to be included in the publication as a whole, so that they may be used as the basis for amendment if necessary. In addition, it should be understood that after reading the above disclosure of this application, people skilled in the art can make various changes or modifications to this application, and these equivalent forms also fall within the scope of protection required by this application.

1-15. (canceled)

16. A storage apparatus comprising two storage controllers and a plurality of storage devices, wherein the plurality of storage devices are connected between the two storage controllers via a plurality of point-to-point data buses to form a loop, one of the two storage controller and a portion of the storage devices form a transmission and control bus group, and the other storage controller and the remaining storage devices form another transmission and control bus group;
Wherein, when one of the two storage controllers fails, the plurality of storage devices and the other storage controller form a transmission and control bus group so as to continue control and data transmission; When any one of the plurality of storage devices fails, the remaining storage devices are rearranged and form two new transmission and control bus groups with the two storage controllers so as to continue control and data transmission.

17. The storage apparatus of claim 16, wherein the storage controller has dual ports.

18. The storage apparatus of claim 16, wherein the plurality of point-to-point data buses are bi-directional point-to-point data buses.

19. The storage apparatus of claim 18, wherein the control and data transmission between the storage controller and the connected storage device is performed via a shared bi-directional data bus, and the control and data transmission between the adjacent storage devices in the plurality of storage devices is performed via a shared bi-directional data bus.

20. The storage apparatus of claim 16, wherein the plurality of point-to-point data buses are one-way point-to-point data buses.

21. The storage apparatus of claim 20, wherein the control and data transmission between the storage controller and the connected storage device is performed via a shared one-way data bus, and the control and data transmission between the adjacent storage devices in the plurality of storage devices is performed via a shared one-way data bus.

22. The storage apparatus of claim 18, wherein the storage controller and the connected storage device are connected through a one-way point-to-point control bus, and the adjacent storage devices in the plurality of storage devices are connected through a one-way point-to-point control bus.

23. The storage apparatus of claim 18, wherein the storage controller and the connected storage device are connected through a bi-directional point-to-point control bus, and the adjacent storage devices in the plurality of storage devices are connected through a bi-directional point-to-point control bus.

24. A storage apparatus comprising two storage controllers and a plurality of storage devices, wherein the plurality of storage devices are connected between the two storage controllers by a plurality of point-to-point data buses to form a linear link;
Wherein when one of the two storage controllers fails, the plurality of storage devices and the other storage controller form a transmission and control bus group; When any one of the plurality of storage devices fails, the other storage devices on both sides of the failed storage device respectively form two transmission and control bus groups with the storage controllers on both sides.

25. The storage apparatus of claim 24, wherein the storage controller has dual ports.

26. The storage apparatus of claim 24, wherein the plurality of point-to-point data buses are bi-directional point-to-point data buses.

27. The storage apparatus of claim 26, wherein the control and data transmission between the storage controller and the connected storage device is performed via a shared bi-directional data bus, and the control and data transmission between the adjacent storage devices in the plurality of storage devices is performed via a shared bi-directional data bus.

28. The storage apparatus of claim 24, wherein the plurality of point-to-point data buses are one-way point-to-point data buses.

29. The storage apparatus of claim 28, wherein the control and data transmission between the storage controller and the connected storage device is performed via a shared one-way data bus, and the control and data transmission between the adjacent storage devices in the plurality of storage devices is performed via a shared one-way data bus.

30. A storage device comprising two bi-directional port groups, wherein each bi-directional port group capable of being linked to a storage controller or a storage device, and the storage device supporting a concurrent bus mode that enables the two port groups of the storage device to be independently connected to two different bus interfaces; When the concurrent bus mode is enabled, the two port groups are set to an output state simultaneously, or set to an input state simultaneously, or one port group is set to the output state and the other port group is set to the input state, or one port group is set to the input state and the other port group is in an undriven high resistance state, or one port group is set to the output state and the other port group is in the undriven high resistance state; When the concurrent bus mode is not enabled, the two port groups are in a low-latency bypass mode.

31. The storage device of claim 30, wherein each of the two bi-directional port group comprising one or more ports.

32. The storage device of claim 31, wherein one or more ports in the bi-directional port group are used for data transmission, and one or more ports in the bi-directional port group are used for control.

33. The storage device of claim 32, wherein the two bi-directional port groups perform read or write operations respectively.

34. The storage device of any one of claim 30, wherein the concurrent bus mode is implemented by port logic, and the port logic and a memory block are encapsulated in a same die to form the storage device.

35. The storage device of any one of claim 30, wherein the concurrent bus mode is implemented by port logic which is encapsulated in a separate die, and the separate die is packaged in the same package with one or more separately encapsulated memory block dies to form the storage device.
